(19) United States
(12) Patent Application Publication
(10) Pub. No.: US 2006/0286423 A1
(43) Pub. Date: Dec. 21, 2006

(54) Gas Composition monitoring arrangement

(76) Inventor: John D. Black, Derby (GB)

Correspondence Address: MANELLI DENISON & SELTER, 2000 M STREET NW SUITE 700, WASHINGTON, DC, 20036-3307, US

(21) Appl. No.: 11/484,730

(22) Filed: Jul. 12, 2006

(30) Foreign Application Priority Data
Feb. 7, 2004 (GB) 0402706.6
Jan. 13, 2005 (WO) PCT/GB05/00073

(51) Int. Cl. H01M 8/10

(52) U.S. Cl. 429/30

(57) ABSTRACT

A gas composition monitoring arrangement for a module 2 used in a solid oxide fuel cell comprises provision of an optically transparent window 4 in the end of a gas flow channel 3 formed in that module 2. Thus, the window 4 allows passive and active optical gas analysis of the gas flow through the channel in situ without the necessity as with previous systems of drawing a proportion of that gas flow away from the module 2 and therefore fuel cell for appropriate analysis. In such circumstances, actual in situ gas composition determination is achieved rather than a determination which may be distorted through the transfer regime to a previous remote gas analysis apparatus.

This is a continuation of PCT Application Number PCT/GB2005/000073 filed Jan. 13, 2005 designating the United States.

The present invention relates to gas composition monitoring arrangements and more particularly such arrangements for use with fuel cells.

A fuel cell is typically a device in which the oxidation of a fuel such as hydrogen is utilised in order to produce electricity. The purpose of any fuel cell is to achieve the most efficient production of electricity by complete oxidation of the fuel within the cell. In such circumstances, accurate monitoring and analysis of both input gas streams and exit exhaust gas flows is important in determining and adjusting fuel cell operation in order to achieve the desired efficiencies. However, it would also be advantageous to analyse gas composition at different stages within the fuel cell in order to achieve closer monitoring of the entire fuel cell operation process and therefore make specific adjustments dependent upon divergences from the ideal conditions.

Previously, it has been known from such documents as EP 1231665, WO 01/92147, WO 98/32003 and U.S. Pat. No. 5,285,071 to provide analysing composition and analysis through utilisation of spectrometers and other devices for analysis principally of liquid or natural gas fuels.

More recently solid oxide fuel cells have been specified. In such systems a gas is oxidised by oxide ions at an anode deposited on the surface of a porous ceramic support. The oxide ions are formed at an air cathode interface and transported through a solid oxide electrolyte layer to the anode. Electrical power is extracted from the external circuit between anode and cathode. Previously, analysis of the gas flow composition has only been achievable at the inlet and outlet to the fuel cell. As indicated above there are great advantages with being able to continuously monitor gas composition and temperature in situ throughout the solid oxide fuel cell operation in order to follow reaction progress within the fuel cell and so optimise operation of the fuel cell.

In accordance with the present invention there is provided a solid oxide fuel cell arrangement comprising at Least one gas flow channel, the at least one gas flow channel having an optically transparent window to view the at least one gas flow channel, an optical gas analysis means being arranged to view the at least one gas flow channel through the optically transparent window and the optical gas analysis means being arranged to determine in situ the gas composition within the at least one gas flow channel.

Typically, the optically transparent window is a clear synthetic sapphire element secured in the end of the at least one gas flow channel. Alternatively, the optically transparent window is formed by a quartz element secured in the end of the at least one gas flow channel. The optically transparent window is typically a block, rod or fibre appropriately shaped to fit within an end of the at least one gas flow channel.

Possibly, where the solid oxide fuel cell arrangement comprises a plurality of gas flow channels the optically transparent window extends over more than one gas flow channel. Advantageously, the optically transparent window provides structural support for the at least one gas flow channel. Possibly, the optically transparent window allows in use access by the optical gas analysis means to different gas flow channels as required.

Possibly, an optically transparent window is provided at both ends of the at least one gas flow channel.

Normally, the optically transparent window is optically aligned to facilitate optical path transfer through the at least one gas flow channel and, in use, the optical analysis means.

Normally, the optically transparent window is secured using a ceramic adhesive. Generally, the at least one gas flow channel acts as a transient gas test cell for in situ gas composition analysis.

Possibly, a reflector is provided at the opposite end of the at least one gas flow channel to the optically transparent window.

Normally, the at least one gas flow channel is formed in an extruded ceramic module. Additionally, the extruded ceramic module is porous to gas constituents when finally formed.

Normally, an optical fibre coupling is arranged between that optical gas analysis means and the optically transparent window.

In accordance with one embodiment of the present invention, the optical gas analysis means is of a passive nature whereby the nascent optical radiation from the gas molecules is utilised in order to determine gas composition within the at least one gas flow channel. Alternatively, in accordance with the second embodiment of the invention, the optical gas analysis means is of an active nature comprising an excitation light source arranged to stimulate gas molecules in order to determine by their response or absorption profile the gas composition within the at least one gas flow channel. Typically, the excitation light source is a laser beam. Advantageously, the excitation light source allows specific interrogation of particular gas composition molecules within the at least one gas flow channel. Possibly, that specific interrogation is achieved through use absorption or Raman spectroscopy.

An embodiment of the present invention will now be described by way of example and with reference to the accompanying drawing in which:

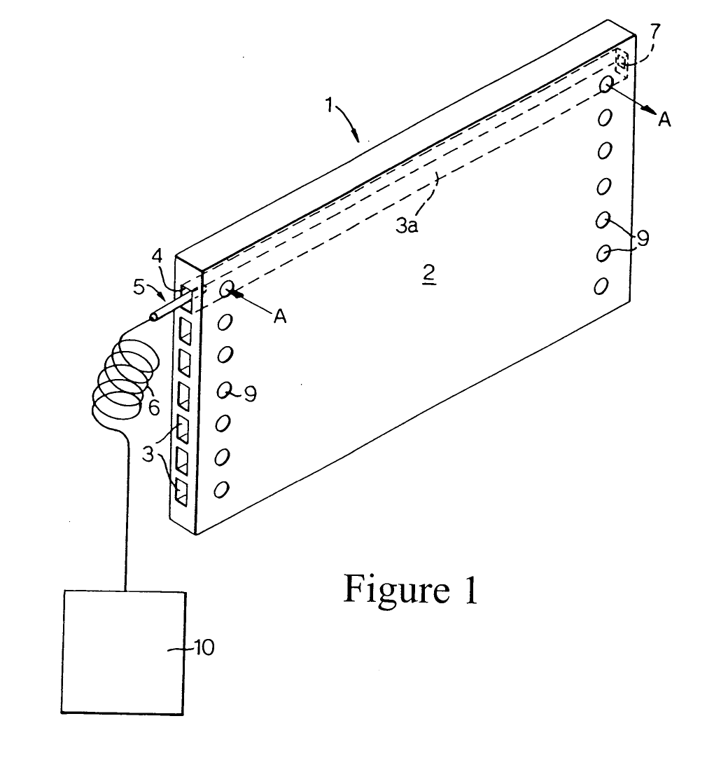

FIG. 1 is a schematic view of a module from a solid oxide fuel cell of the present invention.

A solid oxide fuel cell module I as depicted in FIG. 1 generally comprises a ceramic module 2 formed from an extruded ceramic substrate which when finally formed is porous. Within the module 2 a number of internal fuel or gas flow channels 3 are provided with gas passing through those channels 3 in the direction of arrowheads A. In such circumstances gas passes along the channels 3, and in accordance with fuel cell operation, a proportion of that lies diffuses through the ceramic substrate of the module 2 to encounter fuel cell electrodes printed upon the outer surface of the module 2. It will also be understood in an operational system there is generally a fuel reforming unit which has a similar architecture to that depicted in the drawing but with reforming catalysts replacing the fuel cell electrode and electrolyte layers.

It will be understood that the generation of electricity through the fuel cell is dependent upon association and disassociation of constituent elements within a gas flow mixture passing along the channels 3. This gas flow mixture may incorporate hydrogen, carbon monoxide, carbon dioxide, water vapour, methane and small amounts of hydrocarbons. In such circumstances accurate determination of the gas flow composition is desirable both at a specification/design stage to achieve a necessary operational performance and also during operation to maintain fuel cell efficiency.

Previously, such gas flow composition analysis was achieved through drawing a proportion of the gas flow in the direction of arrowheads A into a separate analytical cell. Unfortunately such an approach inherently leads to potential problems with respect to reactions of the gas constituents in the transfer piping to the analysis cell, distortion due to changes in temperature and pressure in that transfer process and provision of the necessary transfer piping from the fuel cells is difficult to engineer in the circumstances.

In order to achieve the necessary oxidation, solid oxide fuel cell systems operate at about 900° c. At that temperature the constituent molecules of the gas flow radiate infra red and possibly visible light. By analysing the spectrum of the radiated light, the relative concentrations of the various molecular species can be determined. The distribution of molecules of a particular species in vibrational and rotational energy levels depends on temperature, so the form of the observed spectrum of that species can also be used to determine temperature.

In accordance with the present invention a light transmitting window is provided at one end of the fuel flow channel in order to provide an in situ analysis of gas flow composition. In such circumstances the gas flow channel 3a is used as a spectroscopjc gas cell enabling gas composition and temperature within the channel to be monitored spectroscopically during actual fuel cell operation rather than by drawing a proportion of gas flow from the channel 3 for separate analysis.

The window 4 is formed in an end of the channel 3 in order to provide an optically transparent window or pathway between the channel 3a and a coupling 5 for an optical gas analysis apparatus 10. Typically, the coupling 5 is secured to the window 4 and then through an optical fibre connection 6, spectroscopic radiation responses are transferred to optical gas analytical apparatus 10 at a remote location.

It will be understood that the window 4 must withstand the operating temperatures of solid oxide fuel cells, which as indicated previously will be in the order of 900° C. The windows must not degrade or variably alter the detected infrared and visible light radiated from the gas flow molecules.

In accordance with the present invention the window 4 is typically made from a sapphire element secured in the end of the channel 3 during fabrication of the module 2. The sapphire element will take the form of a block, rod or fibre secured in the end of the channel 3a in such a way that it can withstand the temperature and transmit radiation at wavelengths below 5 micrometres, that is to say well within the mid infrared range covering some of the fundamental wavelengths for water, hydro carbons and carbon dioxide. The window will be secured through an appropriate ceramic adhesive in order that its position is maintained. It will be understood that generally there is limited if any pressure differential across the window so the means for securing the window within the end of the channel 3a will not need to resist any high pressures from within the channel 3a. As an alternative to the use of sapphire, quartz may be used, but its optical transmission is limited and mostly in the near infrared and visible light ranges.

The present invention depends upon, as indicated, excited, radiated infrared and visible light from the molecules within the gas flow.

At operating temperature, there will also be considerable radiation from overtones of vibrations in the near infrared, and possibly even in the visible part of the spectrum. Near infra red wavelength regions which can be monitored are ˜1.3 μm for water, ˜1.7 μm for hydrocarbon (including methane), ˜2.1 μm for carbon dioxide, and ˜2.5 μm for carbon monoxide. Thus dependent upon the strength and proportions of radiation responses it is possible to determine passively through an optical gas analysis means the relative constituents in the gas flow during operation of the solid oxide fuel cell.

As indicated previously, an optical fibre link 6 to a spectrometer 10 utilised for optical gas analysis outside of the fuel cell system may be used. Alternatively, free space transmission to a spectrometer 10 through the window or through an access rod, typically the coupling 5 is also possible. However, it will be appreciated in such circumstances it is necessary to secure the spectrometer 10 near or adjacent to the module 1 and this may cause particular accommodation as well as engineering problems.

Passive analysis clearly has benefits with respect to its being cheaper than active analysis in which an excitation light source is introduced. It will also be understood that by use of a monitoring arrangement in accordance with the present invention, a control loop system can be devised whereby variations in the gas composition temperature can lead to adjustments in gas flow rates and/or other operating parameters in order to adjust and improve fuel cell operational efficiency.

As an alternative to passive analysis, it will be appreciated that an active analysis of the gas flow may be achieved. An active spectroscopic system is where light is introduced through the window 4. A reflector 7 could be mounted at the other end of the channel 3a, doubling the effective path length, for absorption spectroscopy. Absorption of the reflected light in the wavelength band of a particular molecular species is proportional to the concentration of that species.

Near infra red or mid-infrared diode lasers could be tuned to specific absorption wavelengths of CO, C0₂, H₂O and hydrocarbon, or minor species, e.g. SO₂ which might affect adversely operation of the solid oxide fuel cell.

The active mode would be more costly and complicated than the passive, but it may be necessary to provide discrimination against background radiation from the ceramic from which the flow channel 3a is formed. The active mode will also have higher sensitivity if it is necessary to monitor minor composition species.

As indicated above, hydrogen, which is the most important species in solid oxide fuel cell operation, does not absorb or emit infrared or visible radiation. However, hydrogen, and the other major species, can be detected by Raman spectroscopy. Here a visible, UV, or near infra red laser IS introduced to the channel in the same way as in the active absorption mode. Backscattered light is then examined with a spectrometer. Some components of the spectrum will be wavelength shifted (Raman shifted) from the incident laser wavelength by amounts characteristic of the particular molecules involved. The intensities of Raman lines are proportional to the concentrations of the molecules involved. Raman shifts occurs on both longer (Stokes) and shorter (anti-Stokes) wavelength sides of the laser wavelength. The Stokes/anti-Stokes ratio is proportional to gas temperature.

If a blue or green visible laser is used, anti-Stokes shifted Raman should be shifted out of range of appreciable radiation from ceramic at 900° C.

By use of the present invention it is possible to determine a gas composition of the gas flow through the channel 3a in a module 2 forming a solid oxide fuel cell. It will be appreciated in practice relatively large numbers of modules 2 will be combined in stacks and units in order to create a cascade to achieve the desired electrical power generation through the combined effects of the modules 2 forming the necessary fuel cells. Clearly, provision of windows and associated means for determining gas composition in each channel of the modules 2 would be impractical. In such circumstances in a control regime utilising a monitoring arrangement in accordance with the present invention, a determination will be made as to the level of analysis required. Thus, as indicated, a number of modules will be incorporated into a bundle, that bundle will then be secured into a strip and strips associated into a block which will then be associated to form a stack for generation of electrical power. Utilising the present invention, an individual module may be analysed through its gas flow composition, but more normally an assembly—of perhaps ten such modules into a bundle will be the lowest addressable analysis unit for control purposes. Thus, if a particular bundle is found to be under performing or acting at divergence from its ideal conditions then adjustments may be made to that bundle, and in severe cases the bundle replaced. Nevertheless, it will also be understood where it is possible through accommodation as well as analysis timings, individual modules may themselves be analysed and the performance determined for design as well as ongoing operational control. Normally, channels at the beginning, middle and end of the module or bundle will be analysed in order to achieve the desired design adjustments and subsequently ongoing control of the solid oxide fuel cell to achieve the desired operational performance and efficiencies.

As indicated above, modules 2 in accordance with known solid oxide fuel cell technology are generally formed from a porous ceramic. The ceramic is initially extruded with the channels formed in the extrusion process. In accordance with the present invention both channels which will incorporate an optical transparent window will have that window incorporated into the extruded ceramic section. The other ends of the channels will be closed with a ceramic slip or other approach. It will be appreciated that when introducing the optically transparent window the interior exposed surface of that window should remain as clean as possible in order that any ceramic debris on that surface does not alter the potential for radiation transfer across the window. It will be appreciated that other structural components of each module will then be incorporated. Thus, as indicated each channel will typically incorporate apertures 9 through which a gas flow in the direction of arrowheads A will be passed. There will also be passages between modules through which the gas flow is presented in a cascade. It will be understood that once assembled the module 2 will be fired to an elevated temperature in order to solidify the ceramic material. When finally fired the module 2 will be substantially porous to gas. Other structures such as electrodes, cathodes and anodes for fuel cell operation as well as possible glazing of certain parts of the ceramic module 2 may also be performed as required. In order to maintain a clean interior window surface, that window surface may upon initial installation within the channel be covered with a self cleaning surface which upon the firing stage is removed in order to leave the clear window surface desired. Typically, the window is secured through a ceramic adhesive which will ensure good location and positioning o the window in use. As indicated previously, there is little pressure differential across the window such that stressing of the ceramic adhesive is low. Nevertheless, it will be appreciated that the window, if it is so natured, must be aligned to take account of polarity effects with respect to radiation. Furthermore, if windows are provided at both ends of the channel 3a, then these windows may be utilised for a through analysis of the gas flow within the channel 3a, that is to say interrogating light injection through a window at one end of the channel and analvsis through the other, then those windows must be optically aligned particularly with respect to polarising effects.

Generally, as indicated above, the optically transparent windows used in accordance with the present invention will be formed from a synthetic manufactured clear sapphire material. Such sapphire materials are preferred due to their controlled nature and Predictability with respect to radiation transfer performance. Furthermore, synthetic sapphire elements can be shaped such that more than one channel may be covered by the window in accordance with the present invention. In such circumstances the window in addition to providing access to each of the channels 3 will also provide additional structural strength to the ceramic material from which the module 2 is formed. Where more than one channel 3 is covered by an optically transparent window in accordance with the present invention, then the means for optical gas analysis can be arranged to interrogate one or more of those channels collectively or individually by transfer of the coupling 5 or provision of couplings to several locations on the optical window associated with different channel positions within the module 2.

By use of the present invention, each individual-channel with an appropriate optically transparent window forms a spectroscopic gas analytical cell. In such circumstances the channel chosen for analysis can be varied quite readily, both in terms of that necessary for design interrogation as well as ongoing control of a fuel cell. In situ analysis of gas flow in comparison with previous remote analysis of gas flow drawn from the fuel cell should be more accurate and reflect actual conditions rather than any distortions caused by that draining of gas flow. A number of known optical gas analysis techniques can be used, but clearly the simplest involves passive analysis of the inherent radiation created by the elevated temperature (circa 900° C.) of the gas molecules within the gas flow. Nevertheless, a second stage of analysis involving introduction of an interrogating light beam through a laser could also be provided, but clearly with added complications with arranging for projection of that interrogating light beam into the channel 3. Finally, comparative analysis techniques such as using a Raman spectroscopic mode of analysis may be used, but again this greatly increases the complexity with respect to installation within a practical operational fuel cell.

Whilst endeavouring in the foregoi˜3 g specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A solid oxide fuel cell arrangement comprising at lest one gas flow channel, characterised in that the at least one gas flow channel having an optically transparent window to view the at least one gas flow channel, an optical gas analysis means being arranged to view the at least one gas flow channel through the Optically transparent window, and the optical gas analysis means being arranged to determine in situ the gas composition within the at least one gas flow channel.

2. An arrangement as claimed in claim 1 wherein the optically transparent window is a clear synthetic sapphire element secured in the end of the at lest one gas flow channel.

3. An arrangement as claimed in claim 1 wherein the optically transparent window is formed by a quartz element secured in the end of the at least one gas flow channel.

4. An arrangement as claimed in claim 1 wherein the optically transparent window is a block, a rod or a fibre appropriately shaped to fit within an end of the at least one gas flow channel.

5. An arrangement as claimed in claim 1 wherein the solid oxide fuel cell arrangement comprises a plurality of gas flow channels, the optically transparent window extends over more than one gas flow channel.

6. An arrangement as claimed in claim 1 wherein the optically transparent window provides structural support for the at least one gas flow channel.

7. An arrangement as claimed in claim 5 wherein the optically transparent window allows in use access by the optical gas analysis means to different gas flow channels as required.

8. An arrangement as claimed in claim 1 wherein an optically transparent window is provided at both ends of the at least one gas flow channel.

9. An arrangement as claimed in claim 1 wherein the optically transparent window is optically aligned to facilitate optical path transfer through the at least one gas flow channel and, in use, the optical analysis means.

10. An arrangement as claimed in claim 1 wherein the optically transparent window is secured using a ceramic adhesive.

11. An arrangement as claimed in claim 1 wherein the at least one gas flow channel acts as a transient gas test cell for in situ gas composition analysis.

12. An arrangement as claimed in claim 1 wherein a reflector is provided at the opposite end of the at least one gas flow channel to the optically transparent window.

13. An arrangement as claimed in claim 1 wherein the at least one gas flow channel is formed in an extruded ceramic module.

14. An arrangement as claimed in claim 13 wherein the extruded ceramic module is porous to gas constituents when finally formed.

15. An arrangement as claimed in claim 1 wherein an optical fibre coupling is arranged between that optical gas analysis means 40 and the optically transparent window.

16. An arrangement as claimed in claim 1 wherein the optical gas analysis means is of a passive nature whereby the nascent optical radiation from the gas molecules is utilised in order to determine gas composition within the at least one gas flow channel.

17. An arrangement as claimed in claim 1 wherein the optical gas analysis means is of an active nature comprising an excitation light source arranged to stimulate gas molecules in order to determine by their response or absorption profile the gas composition within the at least one gas flow channel.

18. An arrangement as claimed in claim 17 wherein the excitation light source is a laser beam.

19. An arrangement as claimed in claim 17 wherein the excitation light source allows specific interrogation of particular gas composition molecules within the at least one gas flow channel.

20. An arrangement as claimed in claim 19 wherein that specific interrogation is achieved through use of Raman spectroscopy.

21. An arrangement as claimed in claim 1 wherein the optical gas analysis means is utilised with a control system for varying the output and/or efficiency of the solid oxide fuel cell dependent upon determined optical gas analysis within the at least one gas flow channel.

22. A method of forming a solid oxide fuel cell ceramic module with at least one gas flow channel, comprising extruding ceramic to form the at least one gas flow channel, placing an optically transparent window at one end of the at least one gas flow channel, and closing the other end of the at least one gas flow channel.

23. A solid oxide fuel cell ceramic module having at least one gas flow channel, one end of the at least one gas flow channel having an optically transparent window, the other end of the at least one gas flow channel being closed.

24. A method of forming a solid oxide fuel cell ceramic module with at least one gas flow channel comprising extruding ceramic to form the at least one gas flow channel, placing an optically transparent window at one end of the at least one gas flow channel and placing an optically transparent window at the other end of the at least one gas flow channel.

25. A solid oxide fuel cell ceramic module having at least one gas flow channel, one end of the at least one gas flow channel having an optically transparent window, the other end of the at least one flow channel having an optically transparent window.
